(19) United States
(12) Patent Application Publication
(10) Pub. No.: US 2004/0039679 A1
(43) Pub. Date: Feb. 26, 2004

(54) Generation and acceptance of tailored offers

(76) Inventors: David W. Norton, Las Vegas, NV (US); Tim Stanley, Henderson, NV (US); Dannielle K. Read, Henderson, NV (US)

Correspondence Address: FENWICK & WEST LLP, SILICON VALLEY CENTER, 801 CALIFORNIA STREET, MOUNTAIN VIEW, CA, 94041, US

(21) Appl. No.: 10/219,922

(22) Filed: Aug. 14, 2002

(51) Int. Cl. G06F 17/60

(52) U.S. Cl. 705/37

(57) ABSTRACT

A system for generating and presenting an offer tailored to a particular user. Information about the user is collected from multiple properties. The information is used to generate tailored offers to the user. The offers are presented to the user. The user easily accepts desired offers.

### CROSS REFERENCE TO RELATED APPLICATIONS

This application incorporates in its entirety: U.S. Pat. No. ______, Ser. No. 09/658,366, entitled, “Resource Price Management Incorporating Indirect Value,” (“Resource Price Management”).

1. Field of the Invention

The present invention relates to automated mechanisms for making and redeeming offers to patrons, and in particular to online systems for making and redeeming offers to patrons of casinos.

2. Background of the Invention

In many industries, providers of products and/or services wish to make offers of products and/or services to potential customers. Traditional methods for accomplishing this include television, radio, and print advertisements. However, with each of these methods, the advertisement is not tailored to the potential customer that receives the advertisement; at best advertisements and offers are targeted to groups of potential customers using demographic or other-techniques, which be definition do not tailor the offer a specific individual. Further, it is difficult for the potential customer to accept such an offer. The customer typically has to visit a particular store during a particular period (before the offer expires), or present a coupon at the store, or the like.

It is desirable to make tailored offers to particular customers based on the indirect value associated with that customer. The casino/hotel industry is an example where the indirect value of a customer can be a substantial component of overall profitability, and therefore important to take into account when making offers for resources. Casinos and hotels are often affiliated with one another, and in many cases are operated by the same company. Most casino/hotel operators recognize that potential income from the casino often far exceeds income from renting rooms at the hotel; yet the hotel component of the business endeavor is a necessary element to attract customers. Thus, many such operators are content to make little or no profit on their room prices (or even offer rooms free of charge) in order to attract customers; the operators rely on increased casino profits from these customers to offset the discounted room prices. As a common enterprise, casino/hotel operators are primarily interested in maximizing total profits, and are willing to take a loss on the hotel operations in order to achieve a greater total profit.

In general, customers may be divided into segments having distinct characteristics and potential revenue or other value. For example, overnight visitors generate higher gaming revenues (i.e., provide greater gaming value) than do day trip visitors. A visitor on an overnight trip tends to do the largest share of her gaming at the casino associated with the hotel at which she is staying. Accordingly, casino/hotel operators whose hotel customers include those overnight visitors having the highest gaming value generally enjoy the highest casino revenues.

Casino gaming is often present in tourist areas offering a variety of attractions. As a result, hotel rooms are often scarce and customers are often turned away. Casino/hotel operators try to determine how many rooms to rent at which price points, in an attempt to maximize revenue. Conventionally, room prices vary based on several factors, including class of room, special events, and availability. Operators forecast the number of rooms in demand at future dates, and set room prices based on these factors. Thus, for periods of high demand, higher room prices may be charged.

However, conventional techniques for setting room prices fail to take into account the potential gaming value of particular customer segments as compared with other customer segments. For example, higher-rated gaming players (i.e., those that belong to a customer segment associated with a higher level of casino profits) are more valuable to a casino/hotel operator than are lower-rated gaming players or non-players. Industry analysis has shown that the 80/20 rule is applicable to casinos: approximately 20% of casino customers provide about 80% of gaming revenues. Thus, where accommodations are scarce, it would be advantageous for hotel/casino operators to favor higher-value customers over lower-value customers.

Furthermore, many higher-rated gaming players book room reservations relatively late, within only a few days of their intended stay. If a hotel is already full by the time the higher-rated player wishes to book a room, the higher-rated player will be turned away. The result is that the room is occupied by a lower-valued customer (who booked earlier) instead of the higher-valued customer. A net loss in total revenues results, due to the failure to take into account the gaming value of each potential hotel customer when pricing or offering the room. Indeed, in some cases, it may be desirable not to rent the room to a lower-valued customer at all, and instead hold open the room for a possible later-booking higher valued customer.

In addition, many current systems, both in the casino/hotel industry and in other industries fail to take into account total potential customer value, including indirect value, in determining whether or not to target a marketing campaign at a customer or customer segment, based on indirect value for the customer or customer segment, or on total value including direct and indirect value. As a result, services and/or goods are offered to potential customers without regard to a determined or estimated total value, including indirect value. As a result, such businesses suffer from misallocation of scarce resources, as well as a lack of optimization and profit maximization.

Further, if the offer is difficult for the customer to accept, the customer is less likely to accept the offer. Thus, it is desirable to generate offers tailored to a particular customer, present the offer to that customer, and allow the customer to immediately and easily accept the offer.

### SUMMARY OF THE INVENTION

One embodiment of the present invention is a tailored offer system that generates offers tailored to particular customers, presents the offers to the customers and allows the customers to easily accept and reserve an offer. Customer activity information is gathered from one or more locations of the business and stored in a patron database in association with an account of the customer. The customer activity information results from any transaction or interaction of the customer with the business that typically generates revenue or value for the business, such as purchases, gaming, dining, or the like. The customer information is used to estimate the indirect value of the customer to the business. Information on available resources is stored in a resource database; a resource is some facility, event, activity, or other item of limited quantity, which the business offers to customers.

An offer generator uses the information in the patron database and the resource database to generate offers tailored to selected customers. A tailored offer offers an instance of a resource at a property to the customer based at least in part on a customer's indirect value, as determined from the collected activity information of the customer at one or more properties. For example, a resource may be an inventory of hotel rooms, and instance of the resource would then a particular type or class of room on a particular date(s). The offer preferably contains a price for the instance of the resource, where the price is also a function of the indirect value of the customer to the business. The offer generator preferably operates to generate offers that have been initiated in advance of the customer's own request for the resource, where the initiated offers are stored in a database, in conjunction with a customer's account.

The system preferably operates to initiate a number of offers for different customers, selected based on characteristics of the customers. The initiated offers are then distributed or transmitted to the customers via a communications network, to be viewed by the customers at a computer, terminal, portable computing device, or other display device. Each customer can view a list of one or more tailored offers which have been generated for that customer. A customer can then select one of the offers to redeem, and provide a date or range of dates on which they wish to reserve the instance of the resource, for example, a range of dates on which they want to reserve a hotel room a particular property. The system then determines whether the instance of the resource is available for the requested period of time, and if so, provides an acknowledgement to the customer. The customer can then confirm the reservation. The system then establishes the reservation and stores an indication that the offer has been redeemed. This approach enables the customer to both determine what tailored offers are available to him, and to immediately reserve the resource described in the offer, without having to make a separate inconvenient action, such as a telephone call to the provider of the resource.

In one embodiment, the business is a hotel and casino. The customer activity about which information is gathered is casino gaming activity. The business calculates an indirect value for the customer based on the amount of gaming activity in which the customer engages. The offer generator then uses the indirect value of the customer to generate an offer for a hotel room tailored to that customer. The customer can then easily accept the offer.

The invention has embodiments in systems and methods which generate offers based on indirect value, computer program products for operating such systems, user interfaces and workflows for selecting customers and generating offers, the tailored offer products themselves, and other aspects of the embodiments.

### BRIEF DESCRIPTION OF THE DRAWINGS

FIG. 1 is a conceptual block diagram of the functional components of the invention according to one embodiment.

FIG. 2 is a block diagram of an embodiment of one of the locations with which the tailored offer system interacts.

FIG. 3a illustrates the initiation “of promotional offers and inventory offers.

FIG. 3b shows events that occur after a user accesses the system and prior to offer generation.

FIG. 3c shows the generation of all three types of offers.

FIG. 3d is a conceptual block diagram of the functional components of the revenue management system according to one embodiment.

FIG. 3e is a flow chart depicting a process of determining a price for a resource according to one embodiment.

FIG. 4 shows an embodiment of a screen for obtaining access to the tailored offer system.

FIG. 5 shows a screen presented to the customer after the customer accesses the tailored offer system.

FIG. 6 shows a screen presented to the customer after the customer requests a customer offer.

FIG. 7 shows a screen presented to the customer after the customer requests promotional offers or inventory offers.

FIG. 8 shows a screen presented to the customer to allow the customer to finish specifying the resource.

FIG. 9 shows a screen presented to the customer after the application server receives the generated offer.

### DETAILED DESCRIPTION OF THE PREFERRED EMBODIMENTS

The present invention allows a business enterprise or entity (e.g., such as a hotel, casino, airline, retailer) to present a customer with an offer tailored to that customer, and allows the customer to easily accept the tailored offer via online communications mechanisms. The offer is generated based on previously collected data of customer activity, from which the indirect value of the customer to the business can be determined. The generation of the offer is preferably initiated by the enterprise offering the resource in order to selectively target particular customers. In an alternative embodiment, the customer initiates generation of the offer.

The following description illustrates the invention in the context of a system for allowing a customer to easily accept tailored offers presented to that customer. The described embodiment focuses on casinos, with emphasis on offers for hotel rooms, where the indirect value of potential casino hotel customers is obtained from gaming activities of the customer while staying at the hotel, and may also be based on other activities as well, such as purchases, dining, and the like. However, the present invention is not intended to be limited to casino hotel room management and pricing, nor to gaming as the only possible source of indirect value. Accordingly, the context of the following description is not intended to limit in any way the scope of the invention, which is defined solely by the claims.

System Functional Components

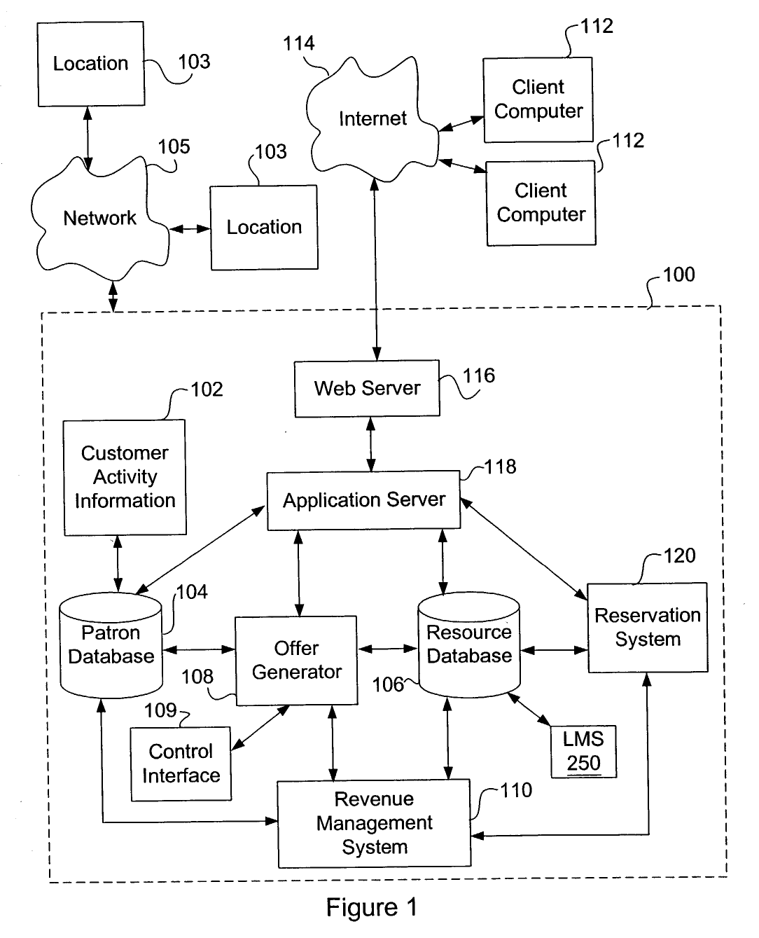

FIG. 1 is a conceptual block diagram of the functional components of the invention according to one embodiment. In this embodiment, a tailored offer system 100 generates tailored offers to a customer based on the customer's activity, presents the offers to the customer, and allows the customer to accept the offer. The various functional elements of FIG. 1 are implemented as software components running on a conventional computer system, as is known in the art.

Customer activity information 102 is collected from one or more locations 103. In one embodiment, the locations 103 from which the customer activity information 102 is collected are casino properties, although customer activity information 102 may also be collected from other types of locations 103, including activities on virtual locations such as websites (e.g., online gaming, online purchases). In one embodiment, patrons are issued player tracking cards and assigned a patron ID. The player tracking cards are used to provide the patrons' ID to various systems at the location 103 that collect customer activity information 102. The player tracking cards are encoded with the patron's ID, and the cards can be swiped at card readers distributed throughout the hotel/casino to provide the systems with the patron's identity. Systems that are connected to the card readers collect the customer activity information 102.

The customer activity information 102 is sent through a network 105 to be stored in the tailored offer system 100 for subsequent use. In various embodiments, the network 105 can be the Internet, a private network (e.g., a WAN, VPN, or the like), or another network. Access to a patron's activities and other data from all locations 103 allows the tailored offer system 100 to implement cross-property incentive programs, manage customer offer programs more effectively, and provide more personalized services to its patrons. One system for collecting and storing patron activity information in a casino is disclosed in U.S. Pat. No. 5,761,647, which is incorporated by reference herein.

A patron database 104 stores the customer activity information 102 received from the locations 103. Generally, the patron database 104 associates the customer activity information 102 for a particular customer with the patron ID associated with each patron's account. The patron database 104 is adapted to provide the tailored offer system 100 with stored data regarding individual patrons, or customers. The patron database 104 includes patron accounts for each patron from all of the supported locations 103. Patron accounts in the patron database 104 include detailed information characterizing the patron, such as the patron's gaming history, lodging history, credit rating, comp level, theoretical win value, and accumulated activity points. Additional personal information may be stored as well, such as the patron's preferences, interests, and the like.

A patron's theoretical win value is determined according to gaming data or other patron activity accumulated at any of the locations 103 affiliated with the enterprise. The theoretical win is an estimate of the amount of revenue to be generated by the customer from gaming activity over some time interval, such as a trip, a 24 hour period, or the like. Theoretical win is one measure of indirect value of a patron. The patron's lodging history may also be stored in the patron's account, along with relevant statistics, such number of stays, dates, lodging revenue per stay, total lodging revenue, and the like. Purchase histories for purchases made at the hotel/casino may also be recorded and statistically summarized. Activity points are determined in part by patron activity, but may also be augmented by special offers and various other promotional programs. Activity points may be derived from straightforward measures of activity volume, such as the amount of coin-in in various casino games. These various measures of customer activity (lodging, gaming, purchases, etc.) may be used to compute an indirect value for the customer.

The patron database 104 also stores any offers that have been initiated for each patron, and whether the patron has accepted the offers. After the offers are initiated, they are linked to respective customers in their patron database 104 accounts. For example, an offer table in the patron database may store a record for each offer for each of the selected customers, including an offer ID identifying the offer. Entries in this table are linked to the patrons' records by a patron ID or other relation. It is also possible to store offers that are available to all patrons. In this case, the offer is stored, along with information indicating that the offer is available to all patrons. Other tables can be used to store descriptive information about the offers, linked to the offer ID. Typically, the description of the offer includes a description of the resource offered, pricing information, and any other relevant information. For example, where the initiated offer is for a type of hotel room, the description would include the property (hotel) at which the room is located, what dates the offer is good for, an expiration date for the offer, blackout dates, and pricing information. Many other database implementations are possible and equivalent, such as providing a master table of offers, and including in each patron's record a list of offer IDs available to that patron.

A resource database 106 stores information on what resources are available. A resource is a quantifiable, saleable commodity or service that is typically provided to a customer in exchange for a payment. In the context of this invention, resources are assumed to be finite in quantity and/or availability. Examples of resources include hotel rooms, airplane seats, concert tickets, and the like. In a hotel/casino embodiment, the resources are hotel rooms, and the resource database 106 is managed by a lodging management system (LMS) 250, such as described in the U.S. Pat. No. 5,761,647, which is incorporated herein by reference, or alternatively, can be a 9700 Hospitality Management System (HMS), provided by MICROS SYSTEMS of Columbia, Md. In these embodiments, the resource database 106 records what rooms exist and on what dates rooms are reserved and thus unavailable, and possibly other information, such as a base price for the rooms. The resource database 106 and the lodging management system may be distributed between the multiple locations 103 or may be centralized at the tailored offer system 100.

An offer generator 108 is in communication with the patron database 104 and the resource database 106. The offer generator 108 is also connected to a revenue management system 110. The offer generator 108 initiates and generates tailored offers based on entered parameters. The offer generator 108 initiates and generates tailored offers, typically with the aid of the revenue management system 110 and other sources of information. When operating in conjunction with the revenue management system 110, the offer generator 108 essentially acts as a requestor. Based on the customer to whom the offer will be made and the identity of the resource to be offered, the offer generator requests the revenue management system 110 to generate a tailored offer to that customer, including a tailored price of the resource.

The tailored offer system 100 also includes one or more control interfaces 109, through which operators, such as employees of the enterprise, may enter commands and parameters to the tailored offer system 100 and request information from the tailored offer system 100. Preferably, the control interface 109 provides a query interface to the patron database 104 to enable the operator to execute queries to select patrons to receive an offer, based on characteristics of the patrons, such as their comp level, demographic information, indirect value or the like. The control interface 109 can be a computer terminal, for example, connected to the rest of the tailored offer system 100. While the control interface 109 is shown as being within the tailored offer system 100, the control terminal 109 may be located at a location 103, where it would be connected to the tailored offer system via the network 105, or at another position, connected to the tailored offer system 100 via the Internet, a private network (e.g., a WAN, VPN, or the like), or another network. Since data accumulated related to a patron (the customer activity information 102) are updated to the patron database 104, an operator using a control interface 109 may access the customer activity information 102, as well as other information in the patron database 104 or resource database 106. The offer generator 108 is communicatively coupled to the control interface 109. Thus, the operator may enter commands through the control interface 109 that indicate the parameters of when the offer generator 108 is to initiate offers, what types of resources the offers should cover (hotel rooms, for example), what benefit the offers should give (for example, a special price on hotel rooms), to what customers or groups of customers the offers should be made, and other commands.

The tailored offer system 100 includes a revenue management system 110, which operates to determine the price of a resource based on a number of factors, including information about the resource (location, actual or predicted availability, etc.) and information about the patron requesting the resource, such as the patron's indirect value. After being requested by the offer generator 108, the revenue management system 110 uses the information in the patron database 104 and the resource database 106 to determine the pricing of each offer/customer combination and returns the offer or multiple offers to the offer generator 108. The Resource Price Management document, referenced above, provides further description of how the resource management system 110 determines prices for resources based on indirect value. The revenue management system 110 returns pricing information for each offer for each customer.

In the described embodiment, the tailored offer system 100 includes an application server 118 and reservation system 120. The tailored offer system 100 further includes a web server 116 connected to the Internet 114, which enables a patron to use a client computer 112 to access and reserve tailored offers. However, customers may access the offers in other ways in other embodiments. For example, customers may receive offers through direct mail, email, or via the telephone.

The patron uses a client computer 112 to access and reserve tailored offers in the embodiment illustrated in FIG. 1. The patron uses a web browser running on the client computer 112 to access a website which is served by the web server 116. The web browser, which gets web pages from the web server 116, provides a user interface for the patron. For some web pages, the web server 116 receives information from the application server 118 that is included in the web page provided to the client computer 112. The web server 116 also receives information entered by the client at the client computer 112. This information is sent from the web server 116 to the application server 118.

The application server 118 is connected to the web server 116, the patron database 104, the resource database 106, the offer generator 108, and the reservation system 120. The application server 118 controls the user interface presented to the patron by the web server 116. The application server 118 obtains information on offers and other aspects of a patron's account from the patron database 104, the resource database 106, the offer generator 108, or the reservation system 120. The application server 118 also receives information from the web server 116 provided to the web server 116 by the patron at the client computer 112. Based on information received from the web server 116, the application server 118 interfaces with one or more of the patron database 104, the resource database 106, the offer generator 108, and the reservation system 120 to provide the patron with information about tailored offers and allows the patron to reserve a selected offer.

The reservation system 120 controls reservations for hotel rooms at one or more locations 103. The reservation system 120 may be a centralized reservation system 120 that controls reservations for all locations 103, or each location 103 may have its own local reservation system 120. When a patron requests to reserve a tailored offer, the reservation system 120 receives the request from the application server 118. The reservation system 120 then determines whether the room(s) requested by the patron with respect to the offer are available for the patron's selected dates. If so, the system 120 provides acknowledgement of the request reservation is available back to the patron's client computer 112. The patron can then confirm the reservation. The confirmation is sent to the reservation system 120. The system 120 then reserves the resource for the customer, and stores the reservation in the resource database 106.

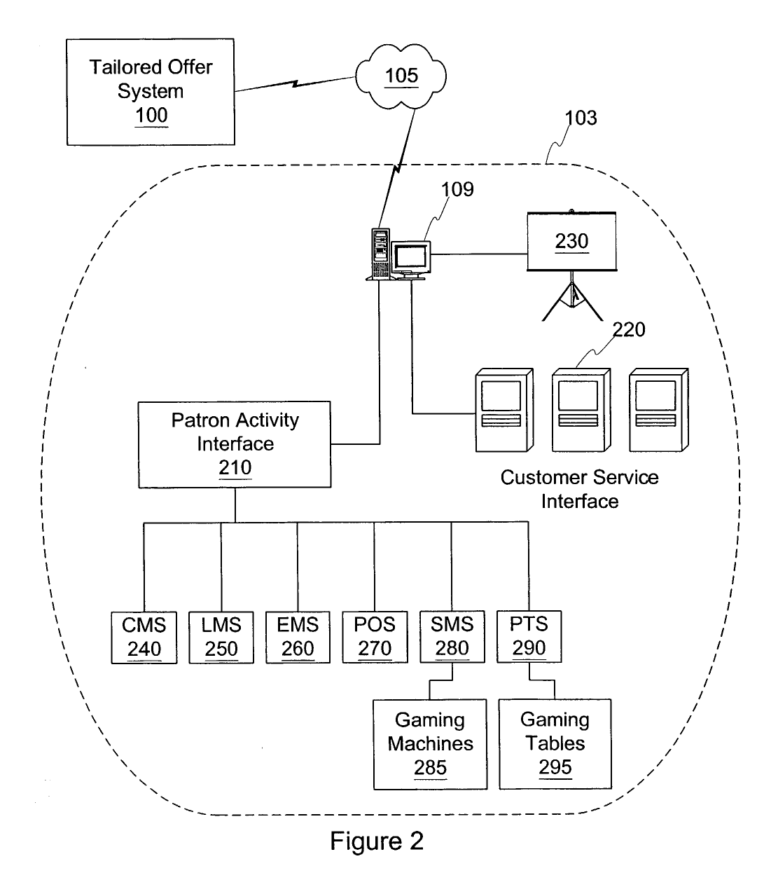

FIG. 2 is a block diagram of an embodiment of one of the locations 103 with which the tailored offer system 100 interacts. Where a location 103 is a physical one (e.g., a hotel or casino), it may be called a property; however, the tailored offer system 100 can interact with other types of locations 103, such as web sites. In some embodiments, each location 103 includes a Patron Activity interface 210 and, one or more control interfaces 109, one or more customer service interfaces 220, and a display system 230. Having a control interface 109 at each location 103 allows local operators to createinitate and customize offers at the location level, in real-time, and in response to market conditions. As noted, the properties 103 are coupled to each other and to the tailored offer system 100 via network 105. In an embodiment, network 105 is a wide-area network. A control interface 109 or another computer system may serve as a gateway from the location 103 to the network 105.

At the location 103 is a Patron Activity interface 210, which in one embodiment uses an API for sending data pertaining to local patron activity, including the customer activity information 102 and other data, over the network 105 to the tailored offer system 100. The Patron Activity Interface 210 communicates with several computer systems for monitoring and tracking casino operations. Depending on the services offered at a location 103, any combination of the following systems might be used to gather patron activity data: a Casino Management System (CMS) 240, a Lodging Management System (LMS) 250, an Event Management System (EMS) 260, a Point of Sale system (POS) 270, a Slot Monitoring System (SMS) 280, and a Pit Tracking System (PTS) 290. U.S. Pat. No. 5,761,647,” and U.S. Pat. No. 6,183,362, the contents of both of which are fully incorporated by reference herein, explains how a CMS 240, a LMS 250, an EMS 260, a POS 270, a SMS 280, and a PTS 290 are used to track patrons' gaming and non-gaming activity at a plurality of affiliated casino properties communicatively coupled by a wide-area network.

In one embodiment, the CMS 240 receives patron data by way of their tracking cards swiped at card readers, workstations, and dumb terminals located at various venues throughout the location 103 and couples the received data to the Patron database 104. The CMS 240 may be a single, centralized system supported on a central LAN at a location, a distributed system comprising local management systems associated with each location's LAN, or a hybrid system including both centralized and distributed components.

The CMS 240 is further adapted to send data to the Patron Activity interface 210. In the context of the present invention, one or more offers are generated for customers, who may then redeem the offers. Typically, an offer is associated with an offer ID, which the system uses to track and identify the type of offer redeemed. The customer may redeem an offer at the location 103, where an operator may manually enter a redeemed offer into the CMS 240 from a local control interface 109. Alternatively, the patrons may redeem offers, e.g., from a client computer 112 coupled to the system over the Internet 114, at a location 103 through use of a customer service interface 220, or using other equipment at a location 103 or elsewhere. When an offer is redeemed at a location 103, the CMS 240 sends data to the tailored offer system 100 that includes the offer ID that was redeemed and the patron who redeemed it.

The LMS 250 comprises the software necessary for managing hotel operations within the casino, including reservations, room service, and other activities associated with hotel operations. In a preferred embodiment of the invention, the LMS 250 communicates with the CMS 240 to search locally for selected customer information available on that system. However, LMS 250 may include its own local data store for customer data. The LMS 250 transmits data regarding patrons' lodging activity to the Patron Activity interface 210 when patrons check in and out of a hotel. In addition, the LMS 250 may transmit lodging data upon a request from the Patron Activity interface 210.210, where it may be sent to the resource database 106 or the patron database 104. The lodging data includes, for example, the dates that a patron stays at a hotel, room service activity, and billing information due to the patron's stay in the hotel. The LMS 250 also communicates, through the Patron Activity interface 210, with the patron database 104, resource database 106, reservation system 120, offer generator 108, and revenue management system 110 of the tailored offer system 100.

The EMS 260 comprises software for handling ticketing information, reservations, and sales. The EMS 260 compiles patron activity data when patrons purchase tickets for an event (such as a show at the location), make reservations for an event, and attend the event. The EMS 260 transmits this data to the Patron Activity interface 210.

The POS 270 comprises accounting software for operating restaurants and retail venues within the location as well as software for transmitting charge information to the other management systems. For example, data relating to meals charged to rooms are transmitted from the POS 270 to the LMS 250, and data relating to redeemed meal comps are transmitted from the POS 270 to the CMS 240. The Patron Activity interface 210 receives data relating to patron's purchases at a location from the POS 270. This purchasing data includes, in an embodiment, the items or services purchased, the restaurant or retail venue where purchased, and the purchase amounts.

The SMS 280 comprises a computer system that monitors and tracks events occurring at the gaming machines 285, including patron activity, such as coin-in, coin out, jackpots, and the like. Gaming machines 285 may include slot machine, video poker machines or the like. In one embodiment, bet tracking is accomplished through a card reader (not shown) associated with a gaming machine 285. A patron inserts his tracking card (described above) in the card reader to initiate a tracking session and removes it to terminate the session. A patron's gaming activity at a gaming machine 285 accumulates in the SMS 280 until the gaming session is terminated or when the CMS 240 requests an account status, at which time the data is transferred to the CMS 240. Bet tracking data accumulated by the SMS 280 includes the identification of the games played, the amount won or lost, and the time period that the patron played the game. U.S. Pat. No. 5,429,361, the contents of which are fully incorporated by reference herein, describes one system for tracking the betting activity of casino patrons at gaming machines.

The PTS 290 is a system that automatically tracks patron activity at gaming tables 295. The PTS 290 is supported on a computer system that transmits patron activity data to the CMS 240. In one embodiment, the PTS 290 uses card readers associated with patrons' positions at the gaming tables 295 to track their betting activity. In one embodiment, data regarding betting activity include a patron's time at a gaming table 295 and the table's minimum bet. U.S. Pat. No. 5,613,912, the contents of which are fully incorporated by reference herein, describes one system for automatically tracking the betting activity of casino patrons at gaming tables. Alternatively, patron tracking at gaming tables is not automatic. Rather, an employee of the enterprise, such as a pit boss, manually enters patrons' gaming data into the PTS 290.

Each of the types of qualifying patron activity described above are communicated to the tailored offer system 100, which can initiate and generate offers that apply to the particular location 103 or to one or more other locations 103, depending on each offer's rules.103. Because the patron activity data is transmitted to the system 100 over the network 105, patron activity in a single location 103 can lead to several offers that may apply to the single location 103 or multiple locations 103.

Offer Generation

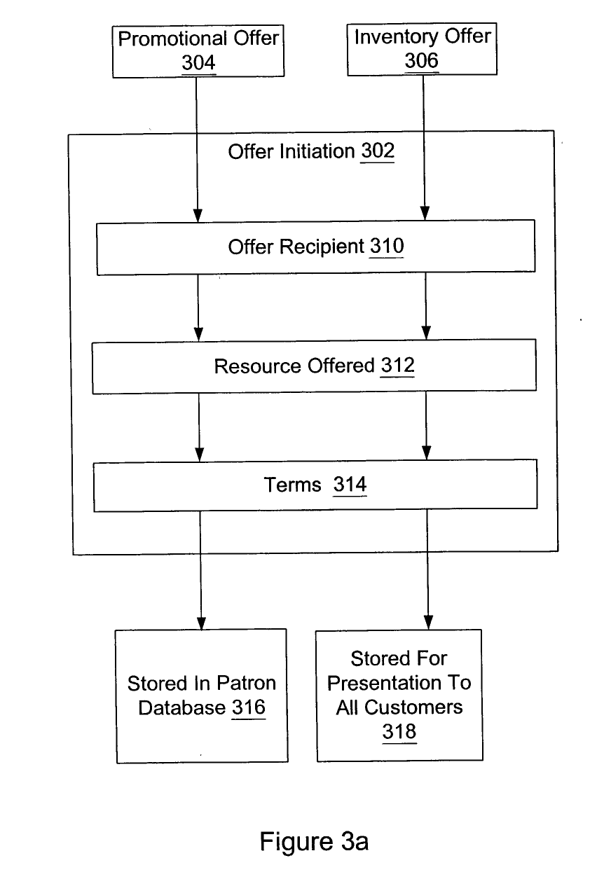

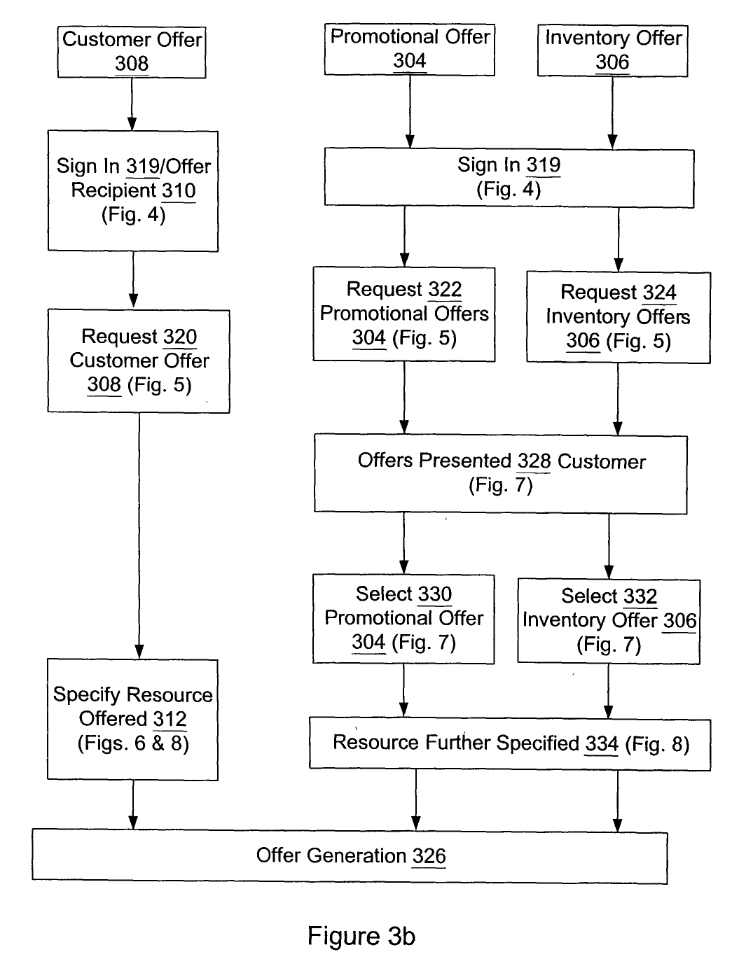

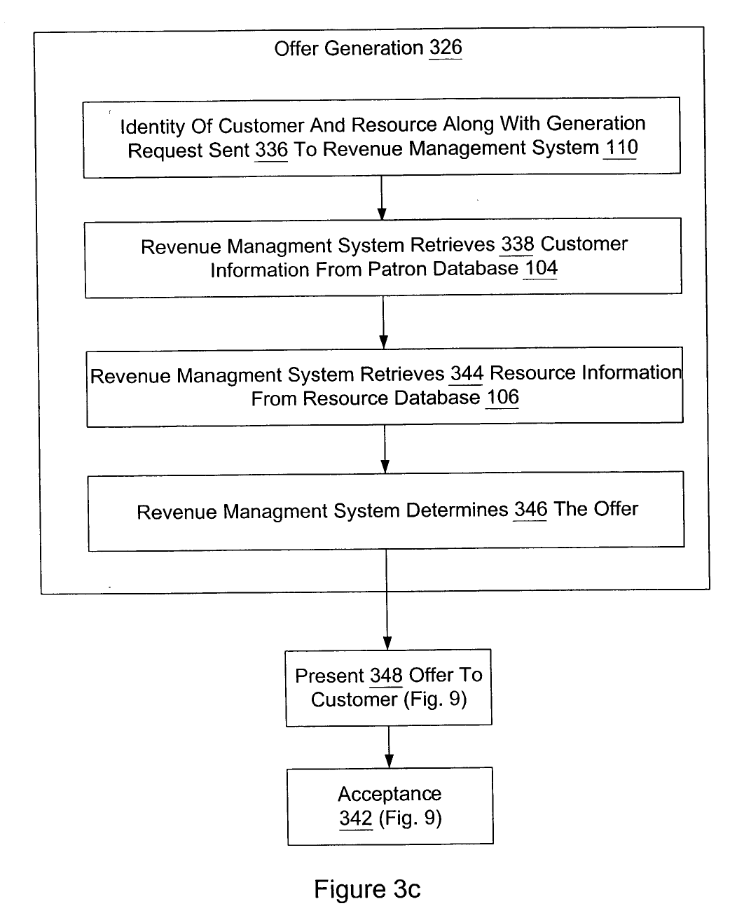

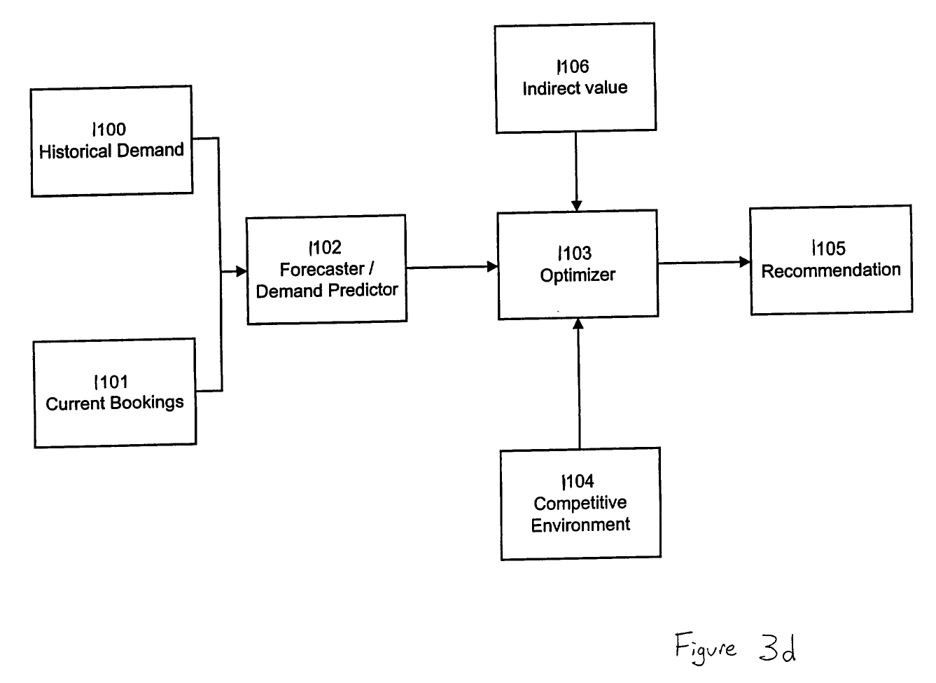

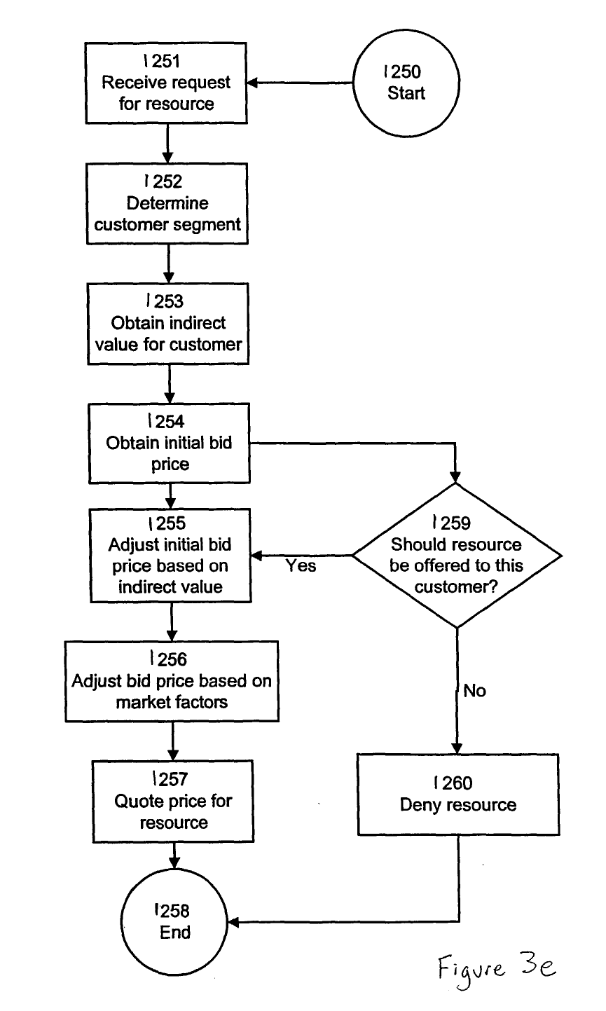

In one embodiment, a tailored offer 340 is first initiated 302, and then generated 326. The diagrams shown in FIG. 3a through FIG. 3c illustrates how offers are initiated 302 and then generated 326 according to this embodiment.

There are three ways to initiate 302 an offer. In the first way, an enterprise initiates offers for promotional reasons. The offers initiated for promotional reasons are known as promotional offers 304. In the second way, an enterprise initiates offers for inventory reasons. The offers initiated for inventory reasons are known as inventory offers 306. In the third way, a patron or customer initiates the offer. The offers initiated by the customer are known as customer offers 308. In offer initiation 302, typically at least two things are specified: the characteristics of the patron 310 to whom the offer will be made, and the characteristics of the resource 312 that will be offered. In addition, in promotional 304 and inventory 306 initiations, terms 314 for the resource are also specified.

FIG. 3a shows the initiation 302 of promotional offers 304 and inventory offers 306, which typically occur prior to a customer accessing the system 100.

In a promotional offer initiation 302, an employee of the enterprise initiates the offer. Typically the employee will do this at regular intervals, such as every other month, or twice a year, or annually. However, the employee can initiate offers at any time. The employee specifies criteria that define offer recipients 310, which are the customers to whom the offer will be made. The employee uses the control interface 109 to enter the criteria into the offer generator 108. In the context of the tailored offer system 100, the criteria are used to select patrons from the patron database 104.

In one embodiment, the control interface 109 includes a rules editor/engine for defining and processing the criteria that are used to determine the offer recipients 310 for promotional offers. 304. A rules editor/engine is a software module that is used to create and process the rules associated with an offer. A rules editor/engine contains software for editing rules and for processing the rules. The criteria for defining offer recipients 310 are the rules entered into the rules engine. Once defined, an offer's attributes and rules are stored in the offer generator 108.

Rules engines are particularly beneficial where there are a large number of rules and where the rules may change frequently. The rules engine also beneficially enables a user—such as an operator—to encode new rules using a language that a business user can easily comprehend. By reducing the reliance on technology personnel, associated costs and turnaround times are reduced.

The rules that define the offer recipients 310 enable the system to precisely target a set of patrons with the tailored promotional offers 304, where the set of patrons is defined by, e.g., certain shared characteristics identified in the patron targeting rules. The patron targeting rules thus define the patrons and enable the tailored offer system 100 to determine whether a patron is an offer recipient 310 eligible for the offer. The following table lists examples of variables that the patron targeting rules use to evaluate conditions, and the actions that any of these rules may take if the conditions are true.

| Variables | Potential Actions |
|---|---|
| Date of Patron X's Most Recent Activity | Set Patron X to be an offer |
| | recipient |
| Patron Account (new to property or | Set Patron X to be an offer |
| brand) | recipient in offer segment Y |
| In direct Value of Patron X | |
| Patron Mail Code/Home Address of | |
| Patron | |
| Patron in Target List (filename) | |

These variables are determined for each patron and, in one embodiment, are stored in and retrievable from the patron database 104. The offer generator 108 applies these variables to the data in the patron database 104 to select the offer recipients 310. An example of a patron targeting rule for only allowing patrons be eligible for an offer if their indirect value is above a predetermined value is: “If [Indirect Value >Z], then [select Patron as an offer recipient 310 for offer].”

The patron targeting rules advantageously allows the enterprise to specifically target patrons for each offer. As can be appreciated, the rule set allows the enterprise to specify a set of conditions or attributes that define which patrons are eligible for a particular offer.

In one embodiment, the criteria to determine the offer recipients 310 to whom the offer will be made are 1) customers that have been active in the last year, and 2) that live in a geographic area more than 75 miles from the location 103, and 3) less than 500 miles from the location 103. In the context of a hotel or casino, an active customer is a customer that has gambled at the casino, stayed at the hotel, or participated in other transactions with the hotel or casino. The offer generator 108 uses these criteria to filter out patrons from the patron database 104. The offers will be made to the patrons that meet the criteria.

In addition to filtering out customers that meet the criteria, the offer generator 108 is capable of splitting the offer recipients 310 into segments based on the customers' indirect value or other criteria. An example of a patron targeting rule that splits offer recipients 310 into segments is: “If [M>Indirect Value >N], then [identify Patron as a member of segment X].”Offer recipients are typically split into segments based on their indirect value.

Other criteria, besides the rules listed in the table and examples above, and other values for the criteria, may also be used to determine the offer recipients 310. For example, in one embodiment, the employee specifically identifies patrons as offer recipients 310 by placing those individuals in a target list. This target list may be a data file stored within or accessible to the tailored offer system 100. This target list allows enterprise personnel to use an external patron targeting mechanism (such as data mining) to construct a list of patrons to be eligible for a particular offer. As shown in the table above, a patron targeting rule can be based on whether a patron is included in the target list. This gives the enterprise a very high level of control to target patrons with a promotion, in addition to generalized rules for patron targeting.

For a promotional offer 304 initiation, the employee also defines what resource 312 will be offered to the customer. In embodiments where the resource offered 312 is a hotel room, the employee typically defines the hotel location 103 of the hotel rooms, what dates the hotel room would be available, how many hotel rooms are available, and what rooms within the hotel will be offered. The employee may also define an expiration date for the offer, and the blackout dates that the resource is not available. The employee may also define other resources, such as show tickets, as the resource offered 312.

Finally, in a promotional offer 304, the employee also defines terms 314 for the offer. These terms will typically include at least pricing information, and may also include other terms of the offer. If the customers to whom 310 the offer will be made have been segmented, the employee defines the terms 314 for each segment of customers. For example, the customers in higher segments, with higher indirect values, will typically receive a better price than customers in lower segments, with lower indirect values. The employee that defines the terms 314 is typically a revenue manager or marketing employee. This revenue manager or marketing employee will use information on predicted demand for the resource as well as response rates to prior promotional offers 304 to determine the term 314. In some embodiments, the employee can also specify whether the terms 314 may be modified during offer generation or are set.

For example, if the resource offered 310 is a hotel room, the employee may define terms 314 for customers in the highest segments, with highest indirect values, that provide the hotel room to the customer on desirable weekend nights for free. In contrast, for customers in the lowest segments, with the lowest indirect values, the employee may define terms 314 that provide the hotel room to the customer only on less-desirable weeknights, and only at a slight discount. Typically, each lower segment will have terms 314 defined that provides a less attractive deal for the resource offered 312 than that of the next higher segment.

After the promotional offer 304 has been initiated, each initiated promotional 304 offer is stored 316 in the patron database 104 linked to the offer recipient 310 for that offer.

In an inventory offer 306, like the promotional offer 304 initiation, an employee of the enterprise initiates the offer. Typically, an inventory offer 306 is made when the employee determines there is excess of inventory for the resource. However, an inventory offer 306 may be made at anytime. The inventory offers 306 are generally intended to sell inventory that is “distressed,” or not being sold as quickly as desired or expected. For example, if a hotel has many rooms that are vacant, an employee of that hotel may initiate inventory offers 306 to try to ensure that the hotel rooms are filled.

Inventory offers 306 can be made available to all potential and current customers or a selected subset. Thus, if everyone is an offer recipient 310, no criteria or rules to filter customers from the patron database 104 are necessary. If the inventory offer 306 is to be made to a selected subset of customers, the rules editor/engine described above for defining and processing the criteria that are used to determine the offer recipients 310 for promotional offers 304 may be used to determine who is an offer recipient 310 of the inventory offer 306.

The employee defines the resource offered 312 in the inventory offer 306. Typically, this is the resource 312 with excess inventory that prompted the initiation of the inventory offer 306. When offering a hotel room as the resource 312, the employee typically defines the hotel location 103 of the hotel rooms, what dates the hotel room are available, how many hotel rooms are available, and what rooms within the hotel will be offered. The employee may also define an expiration date for the offer. The employee may also define a maximum number of hotel rooms that will be available through the inventory offer 306. The employee may also define other types of resources to be offered 312 besides hotel rooms.

As with promotional offers 304, the employee defines terms 314 for the inventory offer 306. The terms 314 generally include a discounted price. The employee that defines the terms 314 is typically a revenue manager or marketing employee. The employee will use information on predicted demand for the resource as well as prior response rates to inventory offers 306 or other offers to determine a discount to be applied to the offer. Since the inventory offer 306 is typically made to everyone, there is usually no need to segment the offer recipients 310 and provide terms 314 for each segment. As with promotional offers 304, the employee may allow later modification of the terms 314, or may define set terms that may not be later modified.

For example, if the resource offered 312 by the inventory offer 306 is a hotel room, the employee may define terms 314 that provide a discount of 50% off a night's stay at the hotel room. This discount will be applied to all resources offered 312 in that inventory offer 306 defined by the employee.

After the terms 314 have been provided, the initiated inventory offer 306 is stored 318 in the patron database 104 and the LMS 250. In some embodiments, the inventory offer 306 is stored with an indication it is available to all customers, if it is available to all customers, or stored 318 in the patron database 104 linked to the offer recipient 310 for that offer.

FIG. 3b shows events that occur after a user accesses the system 100 and prior to offer generation 326, including initiation of customer offers 308 and selection and further specification of promotional offers 304 and inventory offers 306.

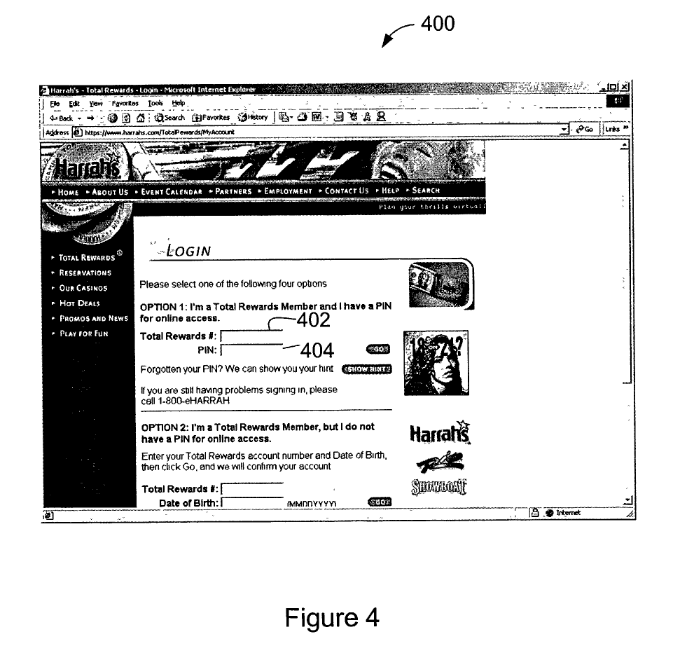

In contrast to the promotional offers 304 and the inventory offers 306, the customer offers 308 are initiated by the customer. When a customer wishes to purchase a resource, the customer initiates a request for a customer offer 308. To do so, the customer accesses the system 100. Typically, as shown in FIG. 4, the customer does this by signing in 319 to the system 100. When signing in, the customer identifies herself to the system 100.

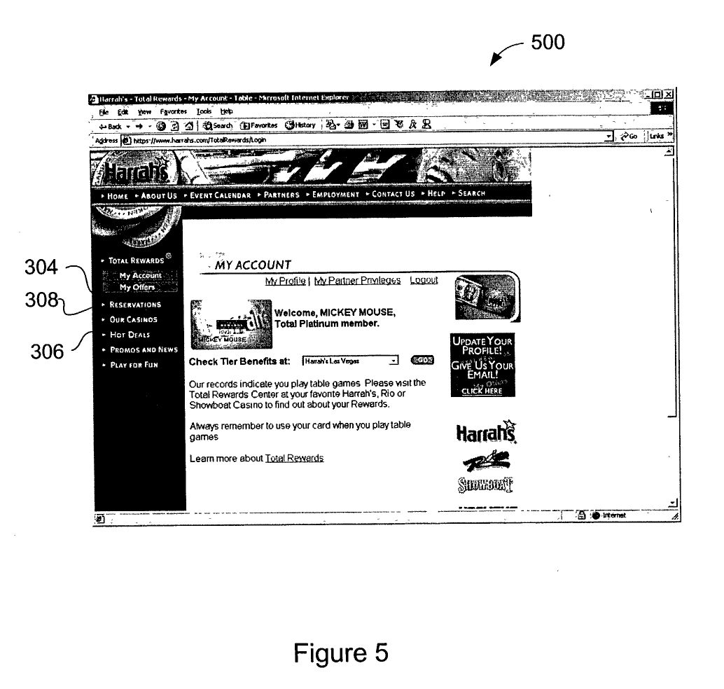

Once the customer accesses the system by signing in 319, the customer requests a customer offer 308 (shown in FIG. 5). With customer offers 308, the offer recipient 310 is the customer that initiates the customer offer 308. Thus, when the customer signed in 319, the customer also specified the offer recipient 310.

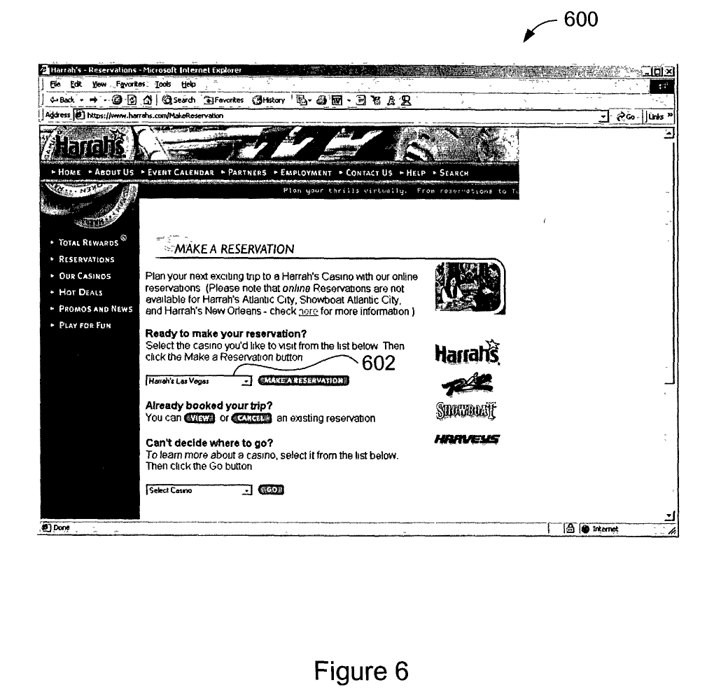

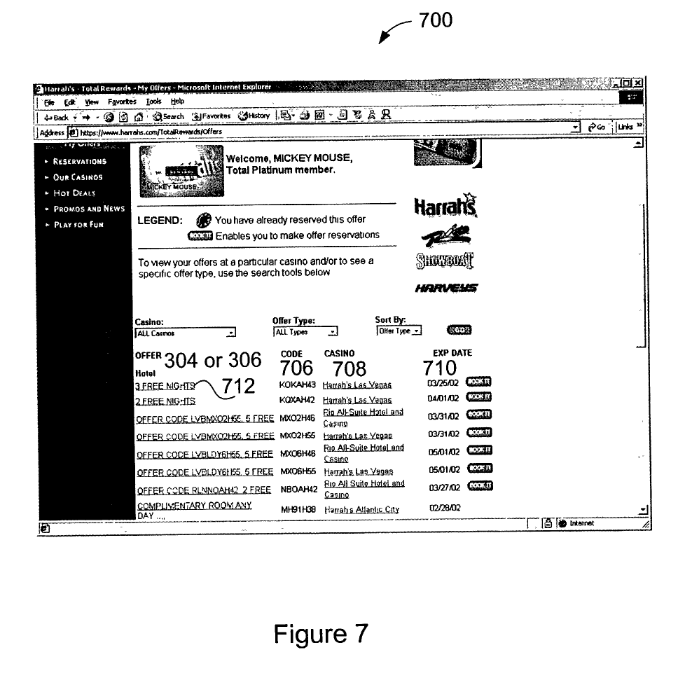

The customer also requests the resource to be offered 312. For example, if the customer wishes a hotel room on a specific night, the customer will specify that particular hotel room on that particular night as the offered resource 312 (shown in FIGS. 6 and 7). The customer may specify any particular resource available as the resource offered 312. Note that in the above examples of promotional offers 304 and inventory offers 306 of hotel rooms as the resource offered 312, the resource offered 312 were only partially defined. Typically, this partial definition was a set of dates the offered hotel room is available. In contrast, in a customer offer 308 for a hotel room, the customer typically fully defines the resource offered 312. The customer may choose to leave a parameter that defines the resource, such as a room type at a hotel, open. If so, the system will provide offers for the various possibilities, such as offers for each room type.

In customer offers 308, the customer does not define any pricing information for the resource offered 312. Additionally, in general, the customer wishes an immediate offer generation in response to initiating a customer offer 308. Thus, no long-term storage is needed for the initiated customer offer 308. Rather, the initiated customer offer 308 is sent directly to offer generation 326, where the offer is generated.

A user may also access the system 100 to request a previously initiated promotional offer 304 or inventory offer 306. To access the system 100 and request either a previously initiated promotional offer 304 or a previously initiated inventory offer 306, the user signs in 319 (shown in FIG. 4). Since many of the promotional offers 304 and inventory offers 306 are tailored to particular customers, supplying the identity of the customer allows the tailored offer system 100 to retrieve initiated offers that are tailored to the specific customer who is accessing the tailored offer system 100.

The customer then requests 322 a promotional offer 304 or requests 324 an inventory offer 306 (shown in FIG. 5). A list of initiated offers is then presented 328 to the customer (shown in FIG. 7). If promotional offers 304 have been requested 322, the initiated promotional offers 304 presented 328 are tailored to customer. If inventory offers 306 have been requested 322, the presented 328 offers are typically presented to all customers, although it is possible to also tailor inventory offers 306.

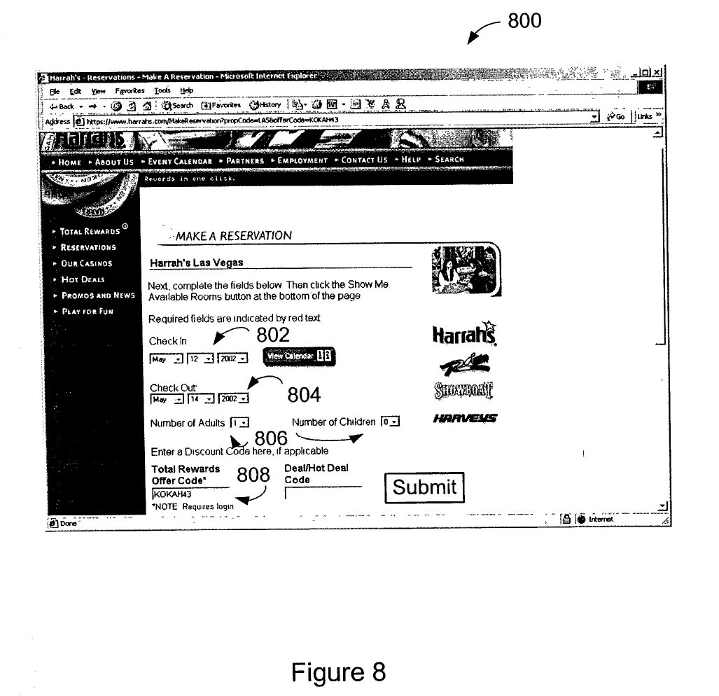

The customer may then select 330 a presented promotional offer 304 or select 332 a presented inventory offer 306. Typically, the customer then further specifies 334 the resource offered (shown in FIG. 8). When the resource offered 312 in a promotional offer 304 or inventory offer 306 is defined, it is possible to only partially define the resource offered 312. This is commonly the case with such resources as hotel rooms, where a range of possible dates, but no particular dates are specified. Thus, when the customer selects such a promotional offer 304 or inventory offer 306, the customer provides information that further specifies 334 and completely defines the offered resource 312. For example, in the case where the resource offered 312 is a hotel room, the date range for the available hotel room may have been defined by employee. The customer further defines 334 the resource by specifying a specific date for the hotel room. The customer may also request dates that are outside the date range of the initiated promotional offer 304 or inventory offer 306; in this case, the additional dates are treated as a customer offer 308. Note that even for hotel rooms, the employee may completely define the offered resource 312. In such a case, further specifying 334 the offer is unnecessary. After further specifying 334 the offer, the promotional offer 304 or inventory offer is generated 326.

FIG. 3c shows the generation 326 of all three types of offers: promotional offers 304, inventory offers 306, and customer offers 308. After the customer has signed in 319 to the tailored offer system 100, selected and further specified 324 a promotional offer 304 or inventory offer 306, or specified the resource in the customer offer 308, the identity of the customer and the exact offered resource 312 are both known.

In some embodiments, the offer generator 108 uses the revenue management system 110 in conjunction with the patron database 104 and the resource database 106 to generate 326 the tailored offer 340. This occurs if the terms 314 do not specify a fixed price. The revenue management system 110 treats each type of offer—promotional offers 304, inventory offers 306, and customer offers 308—in the same way. The offer generator 108 sends 336 the identity of the customer and the identity of the resource for which the offer is desired to the revenue management system 110 and requests an offer. The revenue management system 110 retrieves 338 any information associated with the customer from the patron database 104 and information associated with the resource from the resource database 106, and uses this information to determine 346 the offer. If there is no information associated with the customer in the patron database 104, default values for the indirect value of the customer may be used by the revenue management system 110. The Resource Price Management application cross-referenced above provides details on how the revenue management system 110 determines 346 the tailored offer 340. To determine 346 the tailored offer 340, the revenue management system 110 determines if the offer should be generated for the requested resource, based on at least in part the indirect value of the patron, and if so, at what price. It may be desirable to indicate that the room is not available on the requested dates, in order to hold the room in inventory for a later booking patron whose indirect value is greater than the requesting patron. The offer determined 346 by the revenue management system 110 is the generated offer.

The tailored offer 340 generated 326 by the revenue management system 110 may be better or worse than the initiated promotional offer 304 or inventory offer 306. For a promotional offer 304, if the customer accesses the tailored offer system 100 and causes the revenue management system 110 to generate the offer immediately after the initiation of the offers, the generated tailored offer 340 will likely be identical or near identical to the initiated offer. However, the passage of time, and the acceptance of offers by other customers will affect the offer generated by the revenue management system. For example, if few customers have reserved hotel rooms since the offer was initiated, and vacancies are high, the revenue management system 110 is likely to generate a better tailored offer 340 than was initiated for that customer. However, if many customers have accepted the offer, and hotel vacancies are low, the revenue management system 110 may generate a worse tailored offer 340 than was initiated for that customer. If too many customers have accepted the offer, the revenue management system may indicate that the resource is no longer available. Other factors may also affect the tailored offer 340 that is generated.

For an inventory offer 306, just as with the promotional offer 304, if the customer accesses the tailored offer system 100 and causes the revenue management system 110 to generate the tailored offer 340 immediately after the initiation of the offers, the generated tailored offer 340 may be identical or near identical to the initiated offer. In addition to the factors listed above with respect to the promotional offer 304 that may cause a better or worse tailored offer 340 to be generated, the identity of the customer for whom the offer is generated is likely to affect the generated inventory offer 306 more than the customer identity affects the generated promotional offer 304. This is because when a promotional offer 304 is initiated, the identity of the customers to whom it will be offered is known. However, since inventory offers 306 are available to all customers, when an inventory offer 306 is initiated, the identity of the customer to whom the inventory offer 306 will be offered is unknown. Typically, the identity of the customer will affect the offer that is generated, based on the customer activity information 102 that is stored in the patron database 104 in association with that customer. Thus, if an inventory offer 306 is generated for a customer with a high indirect value, the generated tailored offer 340 may be much better than the initiated inventory offer 306. In contrast, if an inventory offer 306 is generated for a first-time customer, with no customer activity data stored in the patron database 104, the offer may simply be the same offer that was initiated. Additionally, if the terms 314 indicate a fixed price, that is the price at which the resource will be offered.

The generated 326 tailored offer 340 is presented 348 to the customer, who then decides whether to accept 342 the tailored offer 340. The customer can easily accept 342 the tailored offer 340.

FIGS. 3d and 3e show the revenue management system 110 and the operation of the revenue management system 110 in more detail.

FIG. 3d is a conceptual block diagram of the functional components of the revenue management system 110 according to one embodiment. In one embodiment, the various functional elements of FIG. 3d are implemented as software components running on a conventional personal computer, as is known in the art.

Optimizer 1103 generates a recommendation 1105 in response to a resource request for a particular customer. Recommendation 1105 includes, for example, an indication as to whether the resource should be made available to the customer, and/or a recommended price for the resource. This recommended price is used as the price at which the resource will be offered at in the tailored offer 340 generated by the tailored offer system 100.

For illustrative purposes, FIG. 3d shows examples of the types of input that may be provided to optimizer 1103 in generating recommendation 1105. One skilled in the art will recognize that the illustrated input types are merely exemplary, and that other factors may be taken into account in generating recommendation 1105. In the illustrated embodiment, historical demand 1100 and current bookings 1101 are provided to a forecaster/demand predictor 1102, which forecasts demand for particular customer segments. Indirect value 1106 (such as customer gaming value), along with forecasted demand developed by predictor 1102, are provided to optimizer module 1103. Indirect value may represent actual measured value, estimated value, or any combination thereof. Indirect value 1106 may be provided according to individual customers, or according to customer segments, as desired. A further input that may be provided to optimizer 1103 is an indicator of competitive market pressures or other environmental factors, such as prices for similar resources available from competitors (e.g. room prices at competing hotels). Additional input and adjustments may also be provided such as for example an indication of expected or actual demand cycles, so as to increase prices when demand is strong.

Taking into account input from predictor 1102, indirect value 1106, and data describing the competitive environment 1104), optimizer 1103 generates a recommendation as to the appropriate resource allocation and prices, in order to maximize total value. Recommendation 1105 may be in the form of a price to offer to a customer, or a recommendation that the resource not be made available to the customer.

Thus, in the context of a casino/hotel operation, recommendation 1105 ensures availability for high-gaming-value customers when appropriate, and makes appropriate trade-offs to ensure availability for mid-gaming-value customers when appropriate.

Referring now to FIG. 3e, there is shown a flow chart depicting the process of determining 346 the offer shown in FIG. 3c according to one embodiment of the present invention.

The request for the resource (such as the hotel room) is received 1251 by the system. In one embodiment, a customer segment for the customer is determined 1252. For promotional offers 304, if the customer was placed in a segment as described above, this segment is used. Alternatively, the segment may be defined, for example in terms of various characteristics of the customer. Customer segmentation allows the resource pricing implemented by the present invention to be performed on a segment-by-segment basis, so that once a particular customer's segment is determined, an offer price can be generated based on the indirect value associated with the customer segment. However, one skilled in the art will recognize that customer segmentation is not required, and that resource allocation and pricing recommendations may be made for individual customers without employing customer segments and without departing from the essential characteristics of the present invention.

Based on the customer segment (or, alternatively, based on information describing the individual customer), an indirect value for the customer is determined 1253. In the context of the casino/hotel operation, such indirect value may represent, for example, gaming revenue that is expected to result from the customer's stay at the hotel. Other types of indirect value may also be determined, as described above. The indirect value may be an expected or actual value, and may be determined based on statistical, predictive, empirical, or other methods.

An initial bid price is obtained 1254 for the resource being requested by the customer. For promotional offers 304 and inventory offers 306, this initial bid price is a term that is determined as described above with respect to step 314 of FIG. 3a. Alternatively, this price may be based on any combination of factors, such as the type of resource, availability, demand, competitive market forces, promotions, and the like. Thus, the initial bid price represents the unadjusted price that would normally be charged for the resource, without taking into account indirect value of a particular customer or customer segment. In one embodiment, the initial bid price is adjusted by various mechanisms, as described in more detail below.

The system then determines 1259 whether the resource should be offered to the customer making the request. In one embodiment, this determination is made based on the indirect value of the customer; thus, a customer would only be offered the resource if his or her indirect value (expected or actual) exceeded a threshold value. The threshold value may be fixed, or may depend on availability, day of week, season, or other factors. Thus, in the casino/hotel example, a room might be offered to a customer only if the expected or actual gaming revenue from the customer exceeded a threshold value.

In an alternative embodiment, the determination in step 1259 is made based on the total value of the customer, taking into account both direct and indirect value. A total value is determined by combining the initial bid price with the (expected or actual) indirect value, and adjusting the bid price if appropriate. If and only if the total value exceeds a threshold, the resource is offered to the customer.

If in step 1259 a determination is made that the resource should not be offered to the customer, the resource is denied 1260 to the customer.

If in step 1259 a determination is made that the resource should be offered to the customer, the system, in one embodiment, adjusts 1255 the initial bid price to take into account the indirect value of the customer. Such an adjustment may be made, for example, by subtracting the indirect value (adjusted by a multiplier value, if desired) from the initial bid price. A minimum adjusted bid price may be set. In an alternative embodiment, step 1255 is not performed, and the system does not adjust the initial bid price.

In one embodiment, the system performs the optional step of adjusting 1256 the bid price further, to account for market factors such as competitive pressures. For example, if competing hotels are offering rooms at lower prices, the bid price for a room may be adjusted downward in order to remain competitive.

Once all desired adjustments have been made, the resource is offered 1257 to the customer at the quoted price.

By performing the above-described steps, the present invention is able to determine, based on indirect value of a customer, whether or not to offer a resource to a customer and at what price to do so, in order to optimize resource allocation and total revenue.

FIGS. 4 through 9 are screenshots that provide more detail on certain actions shown in FIGS. 3b and 3c, including how the customer accesses and interacts with the system 100 to initiate customer offers 308, requests, selects, and further specifies the resources in promotional offers 304 and inventory offers 306, and accepts 342 the generated 326 offer. In the embodiment shown in FIGS. 4 through 9, the customer accesses the tailored offer system 100 using a browser running on a client computer 112 that presents the customer with multiple web pages generated by the tailored offer system 100 and sent to the client computer 112 by the web server 116. However, other methods are possible, such as by using a customer service interface 220 at location 103, for customers to access the tailored offer system 100.

FIG. 4 shows a screen 400 for obtaining access to the tailored offer system 100. The customer signs in 319 by entering their player tracking account number in field 402 and a password in a PIN field 404. This information is sent to the application server 118 via the Internet 114 and the web server 116. This information is used with the patron database 104 to determine the identity of the customer that is accessing the tailored offer system. Since the offer is tailored to a particular patron, supplying the identity of the patron allows the tailored offer system 100 to retrieve initiated offers and generate offers that are tailored to the specific customer who is accessing the tailored offer system 100.

FIG. 5 shows a screen 500 presented to the customer after the customer accesses the tailored offer system 100 and identifies herself using screen 400. This screen 500 is sent to the client computer 112 in response to the customer entering her account number and password into screen 400. In the embodiment shown in FIG. 5, the user may then request different types of offers from the tailored offer system 100. Here, the customer may request 322 promotional offers 304 that have previously been initiated by the tailored offer system 100 and stored in the patron database 104 in association with that particular customer by selecting “My Offers” in FIG. 5. The customer may also request 324 inventory offers 306 that have previously been initiated and are available by selecting “Hot Deals” in FIG. 5. Finally, the customer may request 320 customer offers 308 that will be generated for that customer in response to the customer's request 320 by selecting “Reservations” in FIG. 5.

FIG. 6 shows a screen 600 presented to the customer after the customer requests, from the screen 500 of FIG. 5, a customer offer 308 that is initiated by the customer. The customer has already identified herself as the patron to whom the offer will be made, by entering the information in FIG. 4. FIG. 6 shows how a customer begins to identify the exact resource for which a customer offer 308 is to be generated 326. Note that typically in promotional offers 304 and inventory offers 306 the resource offered 312 has already been partially specified during offer initiation 302. However, when a customer requests to initiate a customer offer 308, nothing has yet been specified. Thus, FIG. 6 represents the information that must be provided by the customer to define the customer offer 308 in as much detail as promotional offers 304 or inventory offers 306 have been defined during their initiation.

In the example shown in FIG. 6, the resource is a hotel room. The screen 600 of FIG. 6 allows a customer to begin to specify a particular hotel room for which the customer wishes an offer to be generated. However, the customer could request an offer for other resources as well. The screen 600 of FIG. 6 requires that the customer indicate which hotel in which the customer desires an offer for a hotel room. The customer does so by selecting a hotel from a list 602 of hotels. The browser running on the client computer 112 sends the identity of the selected hotel to the application server 118.

FIG. 7 shows a screen 700 presented to the customer after the customer requests, from the screen 500 of FIG. 5, promotional offers 304 or inventory offers 306 that have previously been initiated by the tailored offer system 100. The customer may also select 330 a particular promotional offer 304 or select 332 a particular inventory offer 306 from the screen 700 in FIG. 7.

If the customer requests promotional offers 304, the tailored offer system 100 will retrieve and present promotional offers 304 that were previously initiated and stored in the patron database 104 in association with that customer. When the application server 118 receives the request for previously initiated promotional offers 304, the application server 118 uses the identity of the customer with the patron database 104 to retrieve stored initiated promotional offers for that customer from the patron database 104. The patron database 104 returns a list of the offers that are available for the patron, including the identification of each initiated promotional offer 304, such as a the hotel location. The application server 118 then sends this information to the web server 116, which creates the web page seen in screen 700.

If the customer requests inventory offers 306, the tailored offer system 100 will retrieve and present inventory offers 306 that were previously initiated and stored in the resource database 106 for presentation to all customers. The resource database 106 returns a list of the inventory offers that are available, including the identification of each initiated inventory offer 306, such as a the hotel location. The application server 118 then sends this information to the web server 116, which creates the web page seen in screen 700. If any inventory offers 306 are stored in relation to the particular customer, these inventory offers 306 will also be similarly retrieved and presented.

Screen 700 shows how promotional offers 304 or inventory offers 306 that have previously been initiated are presented to the customer. As shown, each promotional offer 304 or inventory offer 306 includes a linked offer name 712, a corresponding offer code 706, a linked property name 708, which in this case the customer can select to receive a further description of the hotel property, and an expiration date 710 for the offer. The customer selects one of the previously initiated offers, such as offer 712. When the customer selects offer 712, the browser running on the client computer 112 sends the identity of the selected initiated offer 712 to the application server 118. The offer code 706 identifies the initiated offer.

FIG. 8 shows a screen 800 presented to the customer that allows the customer to finish specifying the resource for promotional offers 304, inventory offers 306, or customer offers 308. If the offer is a promotional offer 304 or inventory offer 306, the customer has selected the offer from the screen 700 shown in FIG. 7. The resource offered has been partially specified by the employee during initiation 302 of the offer. The screen 800 of FIG. 8 allows the customer to further specify 334 the resource. If the offer is a customer offer 308, the customer has partially specified the resource as shown in screen 600 of FIG. 6. The screen 800 of FIG. 8 allows the customer to finish specifying the resource.

As shown in FIG. 8, the customer may complete the identification of the resource for which the customer wishes the tailored offer system 100 to generate an offer. In the illustrated case of the resource being a hotel room, the customer does this by selecting the date 802 of the first night of their stay, the date 804 of the last night of their stay, and indicating how many people 806 will stay at the hotel.

In addition, screen 800 includes the code number 808 that the application server 118 has filled in with the offer code from screen 700, which identifies the offer (for customer offers 308, such an offer code is not applicable and would not be filled in). The browser running on the client computer 112 sends the selected dates and number of people, and the offer code, to the application server 118. This information completely specifies the particular resource for which the customer wishes the tailored offer system to generate an offer.

The tailored offer system 100 uses this information to generate the offer. If the offer is a promotional offer 304, the application server 118 makes sure the customer has not previously accepted the offer (since in some cases, as when the promotional offer is for free hotel nights, the entity would lose money if the customer were able to accept such an offer multiple times) by checking the patron database 104. The application server 118 also checks the expiration date of the offer to make sure the offer has not expired. If the offer has expired, the generation process does not proceed. If the offer has not expired, the application server 118 queries the reservation system 120 to check the availability of the hotel room at the specified property for the dates requested by searching the resource database 106. The application server 118 then sends the information on the customer and the resource to the offer generator 108. This information is then received by the offer generator 108 and used to generate 326 the tailored offer 340.

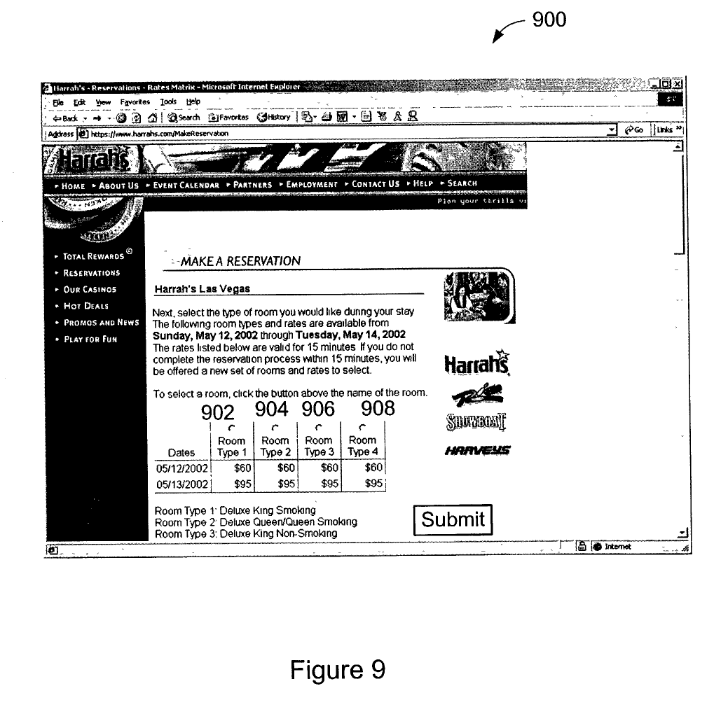

After offer generation, the offer generator 108 sends the generated offer or offers available to the customer to the application server 118. FIG. 9 shows a screen 900 presented to the customer after the application server 118 receives the generated offer. This screen 900 presents 348 the generated offer to the customer. The application server 118 sends the generated offer information to the web server 116, which generates a web page that contains the information, such as the web page shown in screen 900. Screen 900 actually contains four different offers generated for the customer, offers 902, 904, 906, and 908. In this case, the complete identification of the hotel room resource left the type of room unspecified, so each generated tailored offer 340 is for the hotel and dates selected by the customer, but for different types of rooms. While each of the offers shown in screen 900 has the same price, it is possible for each room type to be different and to be priced differently. In addition, if the customer has a high indirect value, the prices may be lower, or the hotel rooms may even be free. This is typically determined by the revenue management system 110; the pricing could have any value so determined by the revenue management system 110 based on the customer's characteristics as shown by the customer activity information 102 stored in the patron database 104, preferably their indirect value.

The customer indicates acceptance 342 of one of the offers by selecting one of the offers 902, 904, 906, or 908. The tailored offer system 100 allows the customer to easily reserve the offered resource when the customer selects one of the offers 902, 904, 906, or 908. When the user selects one of the generated offers 902, 904, 906, or 908, the web browser on the client computer 112 sends information indicating which offer was selected to the application server 118. The application server 118 sends this information along with the identity of the customer to the reservation system 120. The reservation system 120 marks the resource as being reserved in the resource database 106.

In one embodiment, the reservation system 120 retrieves from the customer's account the customer name, address, credit card information and the like to complete the required data for the reservation (alternatively, this retrieval and population of the reservation data can be done earlier in the process flow). The web page shown in screen 900 may also show this retrieved information to the customer for confirmation.

When the customer selects an offer, the reservation system 120 generates a confirmation number, and provides this back to the application server 118. The application server 118 creates a confirmation web page (not shown) with the confirmation number, and the details of the reservation and provides it back to the customer at the client computer 112. Optionally, the customer can then confirm the reservation via the confirmation web page. The reservation system 120 then finalizes the reservation for the customer. The reservation system 120 updates the resource database 106 as needed.

Since many promotional offers 304 may only be accepted once by a customer, if the offer generated was a promotional offer 304, the application server 118 records the fact that the customer has now accepted the promotional offer 304 in the patron database 104. Thus, the customer cannot later accept the offer again. Since the inventory offer 306 may have a maximum number of offered resources that may be accepted, the application server 118 stores an indication in the resource database 106 of how many resources have been accepted based on the inventory offers 306. The reservation system 120 also works with the application server 118, the web server 116, and the browser running on the client computer 112 to complete any other necessary steps in a particular reservation process. Thus, the customer can easily accept the tailored offer.

While the invention has been particularly shown and described with reference to some embodiments, it will be understood by persons skilled in the relevant art that various changes in form and details can be made therein without departing from the spirit and scope of the invention.

We claim:

1. A computer-implemented method for generating an offer specific to a customer, comprising:
selecting a customer to receive an offer to use an instance of a resource;
determining an indirect value of the customer based on collected activity information from activity of the customer at one or more properties;
associating the offer for the customer with an account of the customer, the offer based on the indirect value of the customer;
providing via a communications network, to the customer, and in response to a request from the customer via the communications network, a list of offers including at least the offer, the list of offers displayed on a communications device used by the customer;
responsive to receiving a request of the customer to reserve an instance of a resource of a selected one of the offers on the list for a selected date(s), processing the request to determine whether the offered instance of the resource is available;
responsive to the resource being available, providing an acknowledgement of the availability of the resource to the customer;
receiving from the customer an acceptance of the offer; and
responsive to receiving the acceptance, reserving the instance of the resource for the customer for the selected date(s) and storing an indication that the offer has been accepted.

2. The method of claim 1, wherein the one or more properties is a plurality of casino properties.

3. The method of claim 2, wherein the collected activity information about the customer includes information about the customer's betting activity.

4. The method of claim 1, wherein the collected activity information about the customer includes information about the customer's purchasing activity at the plurality of properties.

5. The method of claim 1, wherein at least one of the plurality of properties is a hotel, and the collected activity information about the customer includes information about the customer's lodging activity at the plurality of properties.

6. The method of claim 1, further comprising:
determining whether the selected one of the offers has previously been accepted; and
responsive to determining that the offer has previously been accepted, preventing acceptance of the offer.

7. The method of claim 1, further comprising, responsive to receiving the request, generating a price for the offer.

8. The method of claim 1, wherein the offer includes at least one term based on a forecasted resource demand.

9. The method of claim 1, wherein the offer includes at least one term based at least in part on the indirect value of the customer.

10. The method of claim 1, wherein the offer includes at least one term comprising pricing information.

11. A computer-implemented method for generating a resource offer specific to a customer, comprising:
monitoring activity of the customer at a plurality of properties;
determining an indirect value for the customer based on the monitored activity;
receiving from the customer a request for an offer for a resource;
responsive to receiving the request, generating an offer specific to the customer for the resource, the offer having at least one term based on the indirect value of the customer;
presenting the offer to the customer;
receiving from the customer a request to redeem the offer; and
responsive to receiving the request, reserving the resource for the customer.

12. The method of claim 11, wherein the at least one term is further based on a forecasted resource demand.

13. The method of claim 11, wherein the at least one term includes a price.

14. The method of claim 13, wherein the price is also based at least in part on a forecasted resource demand.

15. A computer-implemented method for generating an offer specific to a customer, comprising:
collecting activity information from activity of the customer at one or more properties;
initiating one or more offers for a resource;
presenting the initiated offer or offers to the customer;
receiving from the customer a selection of at least one initiated offer;
in response to the selected offer, generating an offer based on the selected initiated offer and the collected activity information of the customer;
presenting the generated offer to the customer;
receiving from the customer an acceptance of the generated offer; and
responsive to receiving the acceptance, reserving an instance of the offered resource for the customer and storing an indication that the offer has been accepted.

16. The method of claim 15, wherein initiating one or more offers comprises defining customers to whom the offer will be made.

17. The method of claim 15, wherein initiating one or more offers comprises at least partially defining the resource to be offered.

18. The method of claim 16, wherein defining the customers to whom the offer will be made comprises:
providing at least one rule to define the customers to whom the offer will be made; and
applying the at least one rule to the customer activity information to determine whether the offer will be made to the customer from which the customer activity information was collected.

19. The method of claim 18, wherein the at least one rule comprises a specification of a minimum indirect value level.

20. The method of claim 19, wherein the at least one rule indicates that if the indirect value of the customer is greater than the minimum indirect value level, the offer will be made to that customer.

21. The method of claim 15, wherein initiating one or more offers comprises specifying terms for the offer.

22. The method of claim 21, wherein specifying terms for the offer comprises specifying a price.

23. The method of claim 22, wherein the price is based at least in part on forecasted resource demand.

24. The method of claim 22, wherein the price is based at least in part on an indirect value of the customer.

25. The method of claim 22, wherein specifying terms further comprises specifying that the price may be modified.

26. The method of claim 22, wherein specifying terms further comprises specifying that the price may not be modified.

27. The method of claim 17, wherein the resource offered is partially defined, and further comprising receiving from the customer information that provides a full definition of the resource when combined with the partial definition.

28. The method of claim 15, wherein generating the offer comprises determining a price for the resource offered to the customer.

29. The method of claim 28, wherein the price is determined based at least in part on the indirect value of the customer.

30. The method of claim 28, wherein the price is determined based at least in part on a forecasted resource demand.

31. The method of claim 15, wherein the offer is initiated by the customer.

32. The method of claim 15, wherein the initiated offer is available to all possible customers.

33. The method of claim 15, wherein the initiated offer is available to a subset of all possible customers.

34. A computer-implemented method for generating an offer specific to a customer, comprising:
collecting activity information from activity of the customer at one or more properties;
generating one or more offers for a resource based on the collected activity information;
presenting the generated offer or offers to the customer;
receiving from the customer an acceptance of the generated offer; and
responsive to receiving the acceptance, reserving an instance of the resource for the customer.

35. The method of claim 34, further comprising storing an indication that the offer has been accepted.

36. The method of claim 34, wherein the generated offer includes a price based at least in part on a forecasted resource demand.

37. The method of claim 34, further comprising defining customers to whom the offer will be made.

38. The method of claim 34, further comprising at least partially defining the resource to be offered.

39. The method of claim 37, wherein defining the customers to whom the offer will be made comprises:
providing at least one rule to define the customers to whom the offer will be made; and
applying the at least one rule to the customer activity information to determine whether the offer will be made to the customer from which the customer activity information was collected.

40. The method of claim 39, wherein the at least one rule comprises a specification of a minimum indirect value level.

41. The method of claim 40, wherein the at least one rule indicates that if the indirect value of the customer is greater than the minimum indirect value level, the offer will be made to that customer.

42. The method of claim 37, further comprising specifying terms for the offer.

43. The method of claim 42, wherein specifying terms for the offer comprises specifying a price.

44. The method of claim 43, wherein specifying terms further comprises specifying that the price may be modified.

45. The method of claim 43, wherein specifying terms further comprises specifying that the price may not be modified.

46. The method of claim 38, wherein the resource offered is partially defined, and further comprising receiving from the customer information that provides a full definition of the resource when combined with the partial definition.

47. The method of claim 34, wherein generating the offer comprises determining a price for the resource offered to the customer.

48. The method of claim 47, wherein the price is determined based at least in part on the indirect value of the customer.

49. The method of claim 48, wherein the price is determined based at least in part on a forecasted resource demand.

50. The method of claim 34, further comprising storing the generated offer in association with the customer.

51. The method of claim 34, further comprising initiating one or more offers for an instance of the resource.

52. The method of claim 51, wherein the offer is initiated by the customer.

53. The method of claim 51, wherein the one or more initiated offers are promotional offers.

54. The method of claim 51, wherein the one or more initiated offers are inventory offers.

55. The method of claim 54, wherein the inventory offers are initiated in response to an excess of inventory of the resource.

56. A system for generating an offer specific to a customer, comprising:
means for collecting activity information from activity of the customer at one or more properties;
means for generating one or more offers for a resource based on the collected activity information;
means for presenting the generated offer or offers to the customer and receiving from the customer an acceptance of the generated offer; and
means for, responsive to receiving the acceptance, reserving an instance of the resource for the customer.

57. The system of claim 56, further comprising means for defining customers to whom the offer will be made.

58. The system of claim 56, further comprising means for at least partially defining the resource to be offered.

59. The system of claim 57, wherein defining the customers to whom the offer will be made comprises:
providing at least one rule to define the customers to whom the offer will be made; and
applying the at least one rule to the customer activity information to determine whether the offer will be made to the customer from which the customer activity information was collected.

60. The system of claim 58, further comprising means for receiving from the customer information that provides a full definition of the resource when combined with the partial definition.

61. The system of claim 56, wherein the means for generating the offer comprises means for determining a price for the resource offered to the customer.

62. The system of claim 61, wherein the price is determined based at least in part on the indirect value of the customer.

63. The system of claim 56, further comprising means for storing the generated offer in association with the customer.

64. A system for generating an offer specific to a customer, comprising:
a patron database for storing activity information from activity of the customer at one or more properties;
an offer generator for generating one or more offers for a resource based on the collected activity information;
a web server for presenting the generated offer or offers to the customer and receiving from the customer an acceptance of the generated offer; and
a reservation system for, responsive to receiving the acceptance, reserving an instance of the resource for the customer.

65. The system of claim 64, further comprising a revenue management system for generating a price for the offer.

66. The system of claim 64, further comprising a control interface for receiving at least one rule to define customers to whom the offer will be made.
